(19) United States
(12) Patent Application Publication
(10) Pub. No.: US 2021/0125276 A1
(43) Pub. Date: Apr. 29, 2021

(54) Display Method, Information Apparatus and Computer Readable Medium

(71) Applicant: JSOL Corporation, Tokyo (JP)

(72) Inventors: Tetsuya Eda, Tokyo (JP); Takehiro Kusumi, Tokyo (JP); Takeru Nitta, Tokyo (JP); Eri Mashiko, Tokyo (JP)

(21) Appl. No.: 16/816,862

(22) Filed: Mar. 12, 2020

(30) Foreign Application Priority Data
Oct. 25, 2019 (JP) 2019-194631

(51) Int. Cl. G06Q 40/02; G06N 20/00

(52) U.S. Cl. CPC G06Q 40/025; G06N 20/00

(57) ABSTRACT

Provided are a display method, an information apparatus, and a computer readable medium for outputting a more objective and more appropriate analysis result. The display method comprises: displaying a network composed of nodes and edges, the nodes representing the plurality of organizations respectively and the edge representing transactional relationships between the plurality of organizations, with an object indicating direction which highlights the edge according to the number of transactions, the transactional relationship and a transactional direction; and displaying a text or an image, for one of the nodes, indicating an index related to growth derived for a target organization corresponding to the one of the nodes and a propagation degree of growth on the organization which has a transactional relationship with the target organization.

### CROSS-REFERENCE TO RELATED APPLICATIONS

This non-provisional application claims priority under 35 U.S.C. § 119(a) on Patent Applications No. 2019-194631 filed in Japan on Oct. 25, 2019, the entire contents of which are hereby incorporated by reference.

### FIELD

The present invention relates to a display method, an information apparatus, and a computer readable medium in which a computer program is recorded.

### BACKGROUND

A method is conventionally proposed that is capable of deriving evaluation data from data such as a strong point, transaction conditions and a credit investigation result of each of target organizations and of presenting the evaluation data in order to refer the evaluation data when determining a loan, strengthening a cooperation between organizations and determining a policy of each organization by a financial institution. Japanese Patent Laid-Open Publication No. 2007-257223 discloses a method of outputting a transactional relationship of companies in a tree form or a map form and of visualizing the transactional relationship. Japanese Patent Laid-Open Publication No. 2007-257223 discloses an example of visualizing a relationship of companies as a network connecting nodes via link lines by marking each company as the node.

### SUMMARY

It is possible for a user to grasp as a whole a relationship between a target organization and neighboring organizations including a client, a related organization, etc. of the target organization by presenting a map as disclosed in Japanese Patent Laid-Open Publication No. 2007-257223. Thus, it is desirable to be able to grasp the relationship since growth and a direction of an organization are not determined by a power of the organization only and are affected by the relation with neighboring organizations.

The present inventors have considered not only a direct relation of a target organization with neighboring organizations but also a growth potential of a community being a set of organizations including the target organization and a relationship of the community with other community, and then have gained an insight of being able to provide a more appropriate analysis data difficult for a human to grasp and for which a propagation effect of an influence between communities is also considered.

The present disclosure has been made based on such an insight, and aims to provide a display method, an information apparatus and a computer readable medium storing a computer program which output a more objective and more appropriate analysis result.

In the display method according to a first aspect of this disclosure, not only an index concerning growth of each of target organizations but also a propagation degree of growth on other organization which has a transactional relationship with the target organization are derived and outputted. It is possible to evaluate individual organizations in consideration of not only growth of the respective organizations but also growth or deterioration of the whole neighboring organizations with other organizations.

In the display method according to a second aspect of the present disclosure, data about a community detected as an organization group which does not evaluated by a human' subjective view is displayed by a network analysis of a network connecting organizations. An organization can be evaluated in view of not only growth of the organization but also data of a community to which the organization belongs.

In the display method according to a third aspect of the present disclosure, in a case where an activity for activating one target organization is conducted, for example, in a case where a financial institution increases a loan for the target organization, it is possible to display a simulation result indicating how the target organization and neighboring organizations grow/deteriorate.

In the display method according to a fourth aspect of the present disclosure, a network concerning a transactional relationship between communities is visualized, and also an association degree between communities is displayed. An association degree with other community is visualized for each community, and it is possible to check an influence degree of a target organization and a community to which the target organization belongs on other community.

In the display method according to a fifth aspect of the present disclosure, an association degree between communities is visualized as a heat map to clarify the association degree between communities.

In the display method according to a sixth aspect of the present disclosure, an organization list according to a business type distribution of organizations belonging to a community and the number of transactions of the organizations belonging to the community is displayed as data of the community. It is possible to check what kind of community.

According to the present disclosure, it is possible to display an analysis result appropriate for growth potentials of a target organization and a circumference including the target organization in consideration of a propagation effect of growth/deterioration on the target organization and a transaction organization. According to this disclosure, a community being an organization group which does not evaluated by an analyzing human' subjective view is defined, and then it is possible to display an analysis result appropriate for growth potentials of a target organization and a circumference including the target organization also in consideration of a propagation effect of an influence between a community including the target organization and other organization.

The above and further objects and features will more fully be apparent from the following detailed description with accompanying drawings.

### BRIEF DESCRIPTION OF THE DRAWINGS

FIG. 1A is a block view showing a configuration of an analysis system of this Embodiment.

FIG. 1B is a block view showing a configuration of an analysis system of this Embodiment.

FIG. 2 is a view showing an example of contents of databases in a storage apparatus.

FIG. 3 is a flowchart showing one example of a first analysis process procedure by an analysis apparatus.

FIG. 4 is a flowchart showing one example of a second analysis process procedure by the analysis apparatus.

FIG. 5 is a flowchart showing one example of a third analysis process procedure by the analysis apparatus.

FIG. 6 is a flowchart showing other one example of the third analysis process procedure by the analysis apparatus.

FIG. 7 is a flowchart showing one example of a fourth analysis process procedure by the analysis apparatus.

FIG. 8 is a flowchart showing other one example of the fourth analysis process procedure by the analysis apparatus.

FIG. 9 is a flowchart showing one example of a fifth analysis process procedure by the analysis apparatus.

FIG. 10 is a flowchart showing one example of a process procedure of outputting an analysis result by an information terminal apparatus.

FIG. 11 is a flowchart showing one example of the process procedure of outputting the analysis result by the information terminal apparatus.

FIG. 12 is a flowchart showing one example of the process procedure of outputting the analysis result by the information terminal apparatus.

FIG. 13 is a display example of a main screen.

FIG. 14 shows an example of a display screen of detail data.

FIG. 15 shows an example of a network display screen.

FIG. 16 is a display example of a propagation degree.

FIG. 17 is a display example of a simulation result.

FIG. 18 shows an example of contents of a community screen.

FIG. 19 is a view showing an example of contents of a detected community.

FIG. 20 is a view showing other example of contents of a detected community.

FIG. 21 is a screen example showing a propagation effect of growth/deterioration of a community.

FIG. 22 is a screen example showing a network characteristic of the community.

### DETAILED DESCRIPTION

The following explains specific examples of an analysis method, an analysis apparatus and a computer program according to Embodiment of this disclosure with reference to the drawings. The following explanation cites an example of an analysis system comprising the analysis apparatus which performs the analysis method and an information terminal apparatus which receives an analysis result.

Note that the present invention is not limited to these illustrations, and is defined by the Claims, which intends to include all the meanings equivalent to the Claims and all the modifications within the scope. The following explanation cites an analyze process for “company” being a profit organization as an example of “organization”. The “organization” may mean a nonprofit organization such as a government and the “organization” may mean a hospital, a company, a corporation, or a firm.

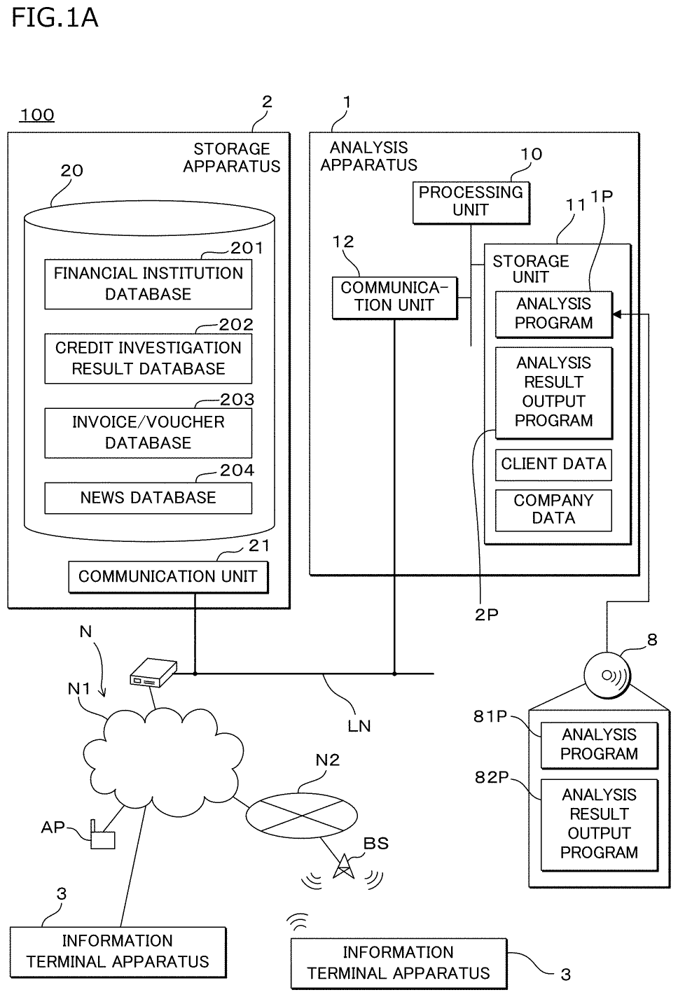

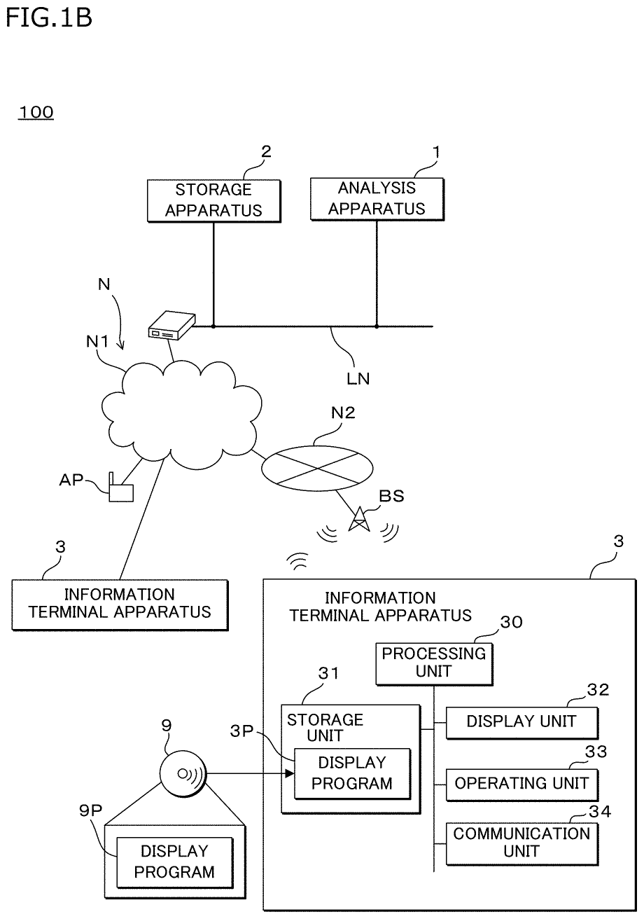

FIG. 1A, 1B are block views showing a configuration of an analysis system 100 of this Embodiment. The analysis system 100 comprises an analysis apparatus 1, a storage apparatus 2 and an information terminal apparatus 3. The analysis apparatus 1 and the storage apparatus 2 are managed by a service provider who provides analysis data including an evaluation of a target company and are connected via a local network LN managed by the service provider. The analysis apparatus 1 can read out data from a financial institution database 201 including transaction information provided from a financial institution, the financial institution database 201 being stored in the storage apparatus 2. The analysis apparatus 1 can also read out data from a credit investigation result database 202 including an attribute and financial information of a company provided from a credit investigation firm. The analysis apparatus 1 can read out data from an invoice/voucher database 203 including an invoice data and a voucher data provided from inter-enterprises transaction platform, the invoice/voucher database 203 being stored in the storage apparatus 2. The analysis apparatus 1 can read out data from a news database 204 including a news data and sentiment data provided from the mass media and the internet, the news database 204 being stored in the storage apparatus 2.

The analysis apparatus 1 calculates analysis data corresponding to a predictive value of growth or deterioration of each of a plurality of target companies in a case of performing an action which contributes to growth such as a loan for the target company or a management advice by means of data read out from the financial institution database 201, the credit investigation result database 202, the invoice/voucher database 203 and the news database 204. The analysis apparatus 1 performs the analysis process by means of the data read out from the financial institution database 201, the credit investigation result database 202, the invoice/voucher database 203 and the news database 204, each time the databases are updated or regularly. The analysis apparatus 1 responds a result of the analysis process according to a request transmitted from the information terminal apparatus 3.

The information terminal apparatus 3 is an apparatus which is used by a user belonging to a client who receives analysis data of a target company. A plurality of information terminal apparatuses 3 can transmit/receive data to/from the analysis apparatus 1 via a network N including a public telecommunication network N1. The information terminal apparatus 3 transmits to the analysis apparatus 1 an analysis request in which a company ID of a target company is specified. The information terminal apparatus 3 obtains analysis data about the target company provided from the analysis apparatus 1 according to the analysis request, and visualizes and displays the analysis data. Financial institutions being a loan supplier, a tax accountant, a management consultant, venture capital investors, group enterprises are defined for clients who receives the provided analysis data.

The following explains details about the configuration of the analysis system 100, the detailed procedure of the analysis process to be performed by the analysis system 100 and the visualization of the obtained analysis result in the information terminal apparatus 3.

The analysis apparatus 1 is a server computer. Although the following explains the analysis apparatus 1 as one server computer which has a function of a Web server, a plurality of distributed server computers may perform a process. The analysis apparatus 1 may be a virtual machine for which a hardware resource of one or a plurality of computer apparatuses is used.

The analysis apparatus 1, as indicated in FIG. 1A, is provided with a processing unit 10, a storage unit 11 and a communication unit 12. The processing unit 10 is a processor for which a CPU (Central Processing Unit) and/or a GPU (Graphical Processing Unit) is used, and has a volatile memory, a clock, etc. built-in. The processing unit 10 can perform the analysis process based on an analysis program 1P stored in the storage unit 11. The processing unit 10 outputs a response according to a request transmitted from the information terminal apparatus 3 based on an analysis result output program 2P stored in the storage unit 11, and transmits the response.

The storage unit 11 includes a non-volatile storage medium such as an SSD (Solid State Drive) or a hard disk. The storage unit 11 stores the analysis program 1P and the analysis result output program 2P. The storage unit 11 also stores a Web server program for performing a process according to a request transmitted from the information terminal apparatus 3 and setting data to be referred by the processing unit 10.

The analysis program 1P and analysis result output program 2P stored in the storage unit 11 may be an analysis program 81P and an analysis result output program 82P which are stored in a storage medium 8 readable by a computer, are read out by the CPU and are stored in a memory.

The storage unit 11 stores company data. The company data includes a company ID of a company being a target company. The company data is key data for referring to a record of the company in the financial institution database 201 of the storage apparatus 2 and a record of the company in the credit investigation result database 202 of the storage apparatus 2 for each company.

The storage unit 11 stores client data. The client data includes account information, network data and contact information, etc. for each client ID of a client who uses service providing analysis data. The client data may include information for specifying financial institution data, credit investigation data, etc. whose use are permitted for each client. For example, data indicating a specific business type may be stored as a certain client's permission object, or data of specific years may be stored as a certain client's permission object.

The communication unit 12 is a communication module which realizes a communication connection between the communication unit 12 and the storage apparatus 2 via the local network LN, and a transmission/reception of data between the communication unit 12 and the information terminal apparatus 3 via the network N. The communication unit 12 is specifically a network card, for example. The communication unit 12 may be a wireless communication module. The communication unit 12 may be a connection interface for communicating with the storage apparatus 2 via a signal line, such as a USB (Universal Serial Bus).

The storage apparatus 2 is provided with a large-capacity storage medium 20 such as an SSD or a hard disk and with a communication section 21. Although the storage apparatus 2 is explained as one storage apparatus 2 in order to facilitate the explanation, storage media of a plurality of storage apparatuses 2 may be virtually treated as one large-capacity storage medium. The storage apparatus 2 receives a request for reading/writing from the analysis apparatus 1 via the communication section 21, and transmits a result of reading/writing.

A personal computer is used for the information terminal apparatus 3, for example. The information terminal apparatus 3 may be a smart phone, a tablet terminal, or a wearable information terminal. The information terminal apparatus 3, as indicated in FIG. 1B, is provided with a processing unit 30, a storage unit 31, a display unit 32, an operating unit 33 and a communication unit 34.

The processing unit 30 is a processor for which a CPU or a GPU is used. The processing unit 30 includes a processor such as a CPU or a GPU and a memory and the like. The processing unit 30 may be configured as one hardware (SoC: System On a Chip) in which the processor, the memory, the storage unit 31 and the communication unit 34 are integrated. The processing unit 30 causes a general-purpose computer to operate as the information terminal apparatus 3 which transmits/receives data to/from the analysis apparatus 1, based on a general-purpose Web-browser-based display program 3P stored in the storage unit 31 and the account information.

The storage unit 31 includes a non-volatile memory such as a flash memory, for example. The storage unit 31 stores the display program 3P. Data to be referred includes the account information including the client ID issued in order to receive service providing analysis data transmitted from the analysis apparatus 1. The processing unit 30 specifies the client ID stored in the storage unit 31, transmits a request of analysis data to the analysis apparatus 1, receives the analysis data transmitted according to the request, and displays an analysis result in the display unit 32, based on the display program 3P.

The display program 3P stored in the storage unit 31 may be a display program 9P which is stored in a storage medium 9 readable by a computer, is read out by a CPU and is stored in a memory.

The display unit 32 includes a display device such as a liquid crystal panel or an organic EL display. The operating unit 33 is an interface which accepts a user's operation, and includes a physical button and a touch-panel device with a built-in display. The operating unit 33 can accept an operation on a screen displayed in the display unit 32 with the physical button or the touch-panel device. The operating unit 33 may include a microphone etc., recognize contents of an operation from an input sound with the microphone, and accept the operation.

The communication unit 34 is a communication module which realizes a transmission/reception of data between the communication unit 34 and the analysis apparatus 1 via the network N. The communication unit 34 may be a network card and communicate via the network N by wire, or may be a wireless communication module corresponding to a Wi-Fi or a career communication or the like and communicate by radio.

The network N includes the public telecommunication network N1 which is what is called the Internet. The public telecommunication network N1 may include an access point AP. The network N includes a career communication network N2 and a base station BS.

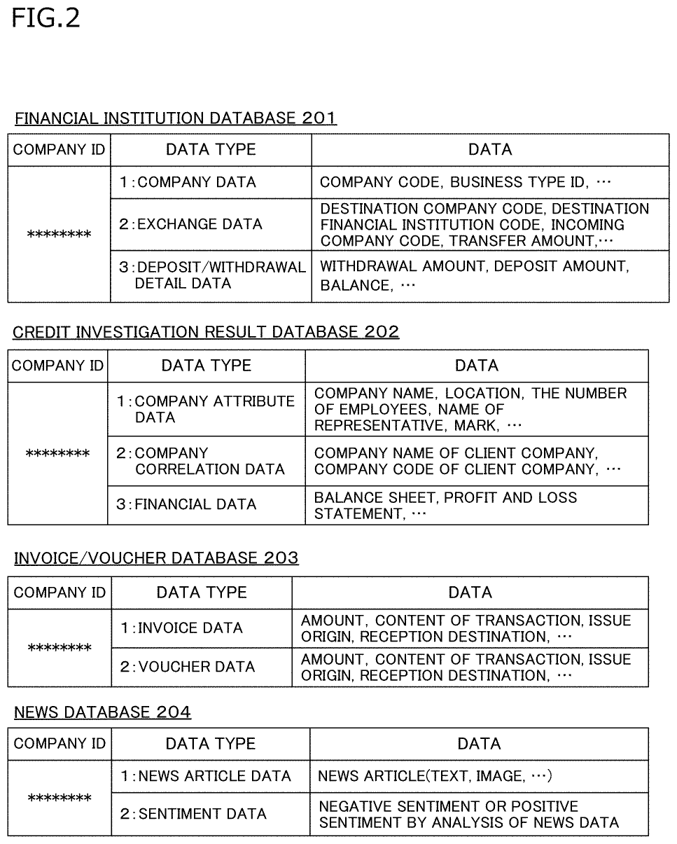

FIG. 2 is a view showing an example of contents of databases in the storage apparatus 2. The financial institution database 201 in the storage apparatus 2 includes company data, exchange data, and deposit/withdrawal detail data for each company. The company data includes a company code, a business type ID or a business type name. The exchange data includes a destination company code, a destination financial institution code, an incoming company code, a transfer amount, etc., and is data which enables the grasp of a transactional relationship with other company. The deposit/withdrawal detail data includes a withdrawal amount, a deposit amount, a balance, etc. of a company. The financial institution database 201 may be added with data provided from a financial institution in a fixed unit, such as a week, a month, a quarter, and a year.

The credit investigation result database 202 of the storage apparatus 2 stores company attribute data, company correlation data and financial data for each company. The company attribute data includes a company name, a location, the number of employees, a name of a representative, a mark, etc. The company correlation data includes data which enables the grasp of a transactional relationship, such as a company name and a company code of a client company. The financial data includes a balance sheet (BS) and a profit and loss statement (PL). The credit investigation result database 202 may be added with data provided from a credit investigation firm in a fixed unit, such as a week, a month, a quarter, and a year.

The invoice/voucher database 203 of the storage apparatus 2 stores invoice data and voucher data for each company. The invoice data includes an amount, content of transaction, an issue origin and a reception destination. The voucher data also includes an amount, content of transaction, an issue origin and a reception destination. The invoice/voucher database 203 may be added with data provided from a management company of the inter-enterprises transaction platform,

The news database 204 of the storage apparatus 2 stores news data and sentiment data for each company. The news data includes text data and image data etc. of news articles. The sentiment data includes data indicating a negative sentiment or a positive sentiment and a degree of the sentiment obtained by an analysis of news data for each company. The news database 204 may be updated by crawling around the Web or contents covered by the mass media.

The following explains the analysis process by means of the data of the financial institution database 201, the data of the credit investigation result database 202, the invoice/voucher database 203 and the news database 204 by the analysis apparatus 1, with a flow divided into a plurality of steps.

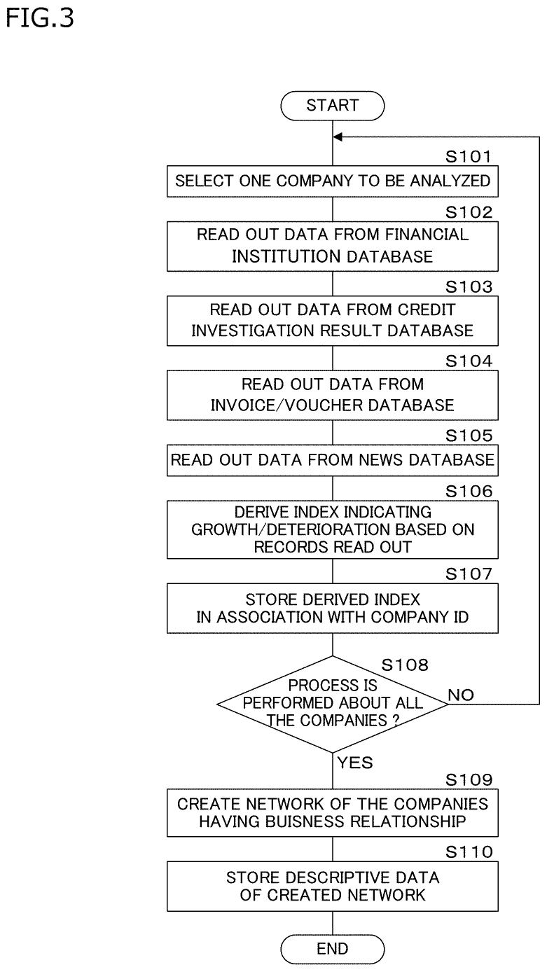

FIG. 3 is a flowchart showing one example of a first analysis process procedure by the analysis apparatus 1. The processing unit 10 of the analysis apparatus 1 selects one company to be analyzed from the company data stored in the storage unit 11 (Step S101). The processing unit 10 reads out the company data, exchange data and deposit/withdrawal detail data of the selected company to be analyzed from the financial institution database 201 of the storage apparatus 2 (Step S102), and reads out the company attribute data, company correlation data and financial data from the credit investigation result database 202 of the storage apparatus 2 (Step S103).

The processing unit 10 reads out the invoice data and the voucher data of the selected company to be analyzed from the invoice/voucher database 203 of the storage apparatus 2 (Step S104). The processing unit 10 read out the news data and the sentiment data of the selected company to be analyzed from the news database 204 of the storage apparatus 2 (Step S105).

The processing unit 10 derives an index indicating growth/deterioration based on a record of the financial institution database 201, a record of the credit investigation result database 202, a record of the invoice/voucher database 203 and a record of the news database 204 referred by a company ID of the selected company (Step S106). At Step S106, the processing unit 10 derives the index based on the financial data of the credit investigation result database 202, the deposit/withdrawal detail data of the financial institution database 201, the invoice data and the voucher data of the invoice/voucher database 203, etc. by an operation with an increase/decrease in creditworthiness and an increase/decrease in sales. The index may be a label indicating any of a plurality of steps of growth/normal/gaze, or may be a value quantified so that as the value is higher a growth degree is high and as the value is lower a deterioration degree is high. For example, the index may be a growth prediction rate of results, such as sales. The processing unit 10 may correct the index in accordance with the sentiment data of the news database 204 so that as the index indicates higher a deterioration degree when the quantity of negative topics is large and as the index indicates higher a growth degree when the quantity of positive topics is large.

At Step S106, the processing unit 10 may use a learning model which has learned so as to output a determination result of a business condition change, such as normal/gaze, in a case where the deposit/withdrawal detail data and the financial data are inputted, for example. This learning model outputs a business condition change after a predetermined period in a case where a series of the deposit/withdrawal detail data in the predetermined period and the financial data are inputted. This learning model has learned as teacher data a correspondence of the actual deposit/withdrawal detail data targeting at all the companies and the financial data with the actual business condition change after the predetermined period.

At Step S106, the processing unit 10 may derive a business condition change based on a model which predicts a business condition change by trend prediction. The processing unit 10 may derive a business condition change with a function set so as to derive a score corresponding to the business condition change, based on a model which uses as a variable data (a balance, the number of deposits, a deposit amount, a summary) or the like included in the financial data or the deposit/withdrawal detail data. The function may be obtained by a deep learning with a neural network.

At Step S106, the processing unit 10 may comprehensively derive the index by combining the trend prediction etc. with the above learning model. It is desirable to improve the accuracy by this learning model relearning continuously each time the financial institution database 201, the credit investigation result database 202, the invoice/voucher database 203 and the news database 204 are updated.

The processing unit 10 stores the index derived at Step S106 in association with the company ID (Step S107). At Step S107, the processing unit 10 stores the index in association with time information (a date, a period) of data about a transaction used as the basis of derivation so as to be able to refer to a history of the index.

The processing unit 10 determines whether or not the process of Step S106 is performed about all the companies included in the company data (Step S108). When the processing unit 10 determines that the process is not performed about all the companies (S108: NO), the processing unit 10 returns the process to Step S101, selects the next company, and performs the process based on records of the financial institution database 201, the credit investigation result database 202, the invoice/voucher database 203 and the news database 204 of the selected target company.

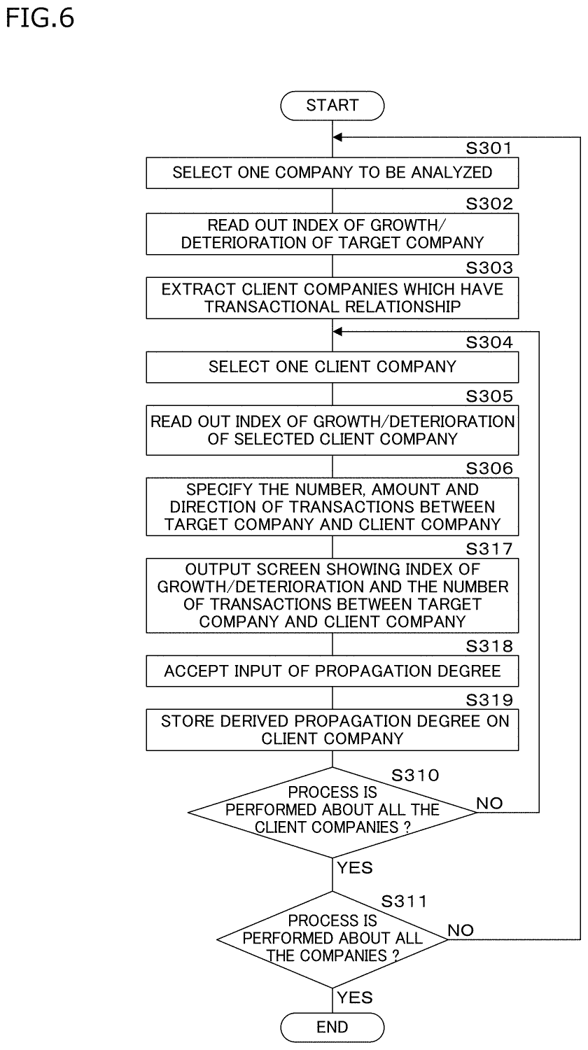

The processing unit 10 creates and updates a network with other companies that a company conducts a transaction about all the stored companies before or after the derivation of the index of growth/deterioration at Step S106 and the storage of the index at Step S107, or simultaneously (Step S109). The processing unit 10 may perform the process at Step S109 in a case where the processing unit 10 determines that the process is performed about all the companies (S108: YES) as shown in FIG. 6. At Step S109, the processing unit 10 creates a network by marking each company as a node and marking presence or absence of the transaction as an edge with a direction and a thickness corresponding to a flow and an amount of the deposit/withdrawal, by means of the company correlation data indicating the transactional relationship in the credit investigation result database 202. The processing unit 10 supplements, to the network created based on the company correlation data, the presence or absence of transaction and the transaction volume by means of information about the transactional relationship included in the exchange data of the financial institution data. A known network generation technology may be used for a method of creating a network.

The processing unit 10 stores in the storage unit 11 descriptive data of the network created at Step S109 (Step S110), and ends the first analysis process.

By the first analysis process, the index of growth/deterioration of each company and the descriptive data of the network are stored each time the financial institution database 201, the credit investigation result database 202, the invoice/voucher database 203 and the news database 204 are updated or periodically.

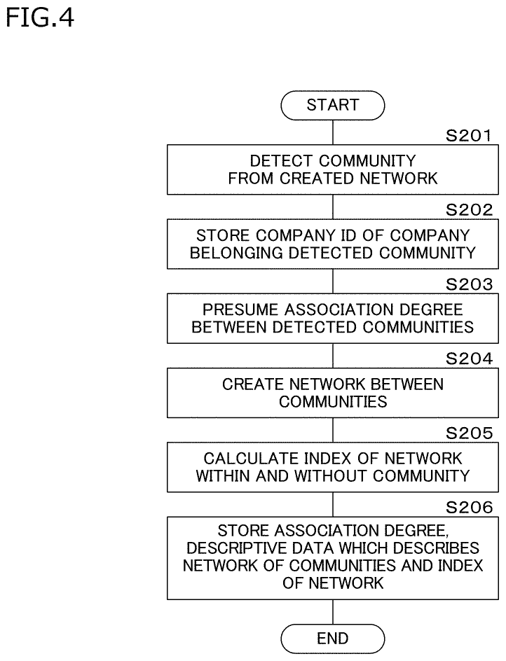

FIG. 4 is a flowchart showing one example of a second analysis process procedure by the analysis apparatus 1. The processing unit 10 of the analysis apparatus 1 detects a company group, i.e., a community by means of transaction correlation data, based on the network created at the first step or a network updated based on the latest data (Step S201). At Step S201, the processing unit 10 applies the infomap method, for example, to detect a community. The method for extracting a community from graph data, such as a method based on “edge betweeness centrality” can be applied to detecting community from network.

When the infomap method is used at Step S201, regarding a community to be detected, a company group determined that treating the company group as a community in the unit is appropriate as a whole is determined as one community, about all the companies stored in the financial institution database 201 and the credit investigation result database 202. Although a community detected by the infomap method is a set of companies, the community is not restricted to a community classified by the business type name included in the company data of the financial institution database 201. The community is determined by a mathematical model. When the infomap method is used, the processing unit 10 gives each node a score (power) corresponding to an index derived for each company, gives the edge corresponding to the transactional relationship a score (power) corresponding to a transaction volume (the number of times, an amount), and performs a simulation which searches for a stable state as dynamic energy to detect a community. A community is detected with the mathematical model by a network analysis (the infomap method for example), and therefore a community with balance whose a mutual influence is appropriate is detected rather than analyzing by a human's subjectivity.

At Step S201, the processing unit 10 can detect a community based on data indicating the number of transactions, a transaction amount, a transactional direction specified from the destination and the incoming corresponding to an edge between nodes, with various methods of network analysis.

The processing unit 10 stores company IDs of companies belonging to the detected community in association with a community ID which identifies the community (Step S202).

The processing unit 10 presumes an association degree between the detected communities (Step S203).

At Step S203, the processing unit 10 presumes the association degree between the companies belonging to the community detected at Step S201 and companies belonging to other community, based on the number of transactions included in the company correlation data of the credit investigation result database 202. The processing unit 10 updates the association degree by means of the data of the destination company code, the incoming company code etc. included in the exchange data of the financial institution database 201.

The processing unit 10 creates a network based on the presumed association degree (Step S204). At Step S204, the processing unit 10 creates data which describes a node as each community and describes an edge according to the association degree between communities.

The processing unit 10 calculates an index of the network within and without the community created at Step S204 (Step S205). At Step S205, the processing unit 10 specifies information, such as the number of companies in the community, the number of edges, an average degree, and the other community with the high association degree. The processing unit 10 may specify information by a statistical method, clustering, etc.

The processing unit 10 stores the association degree presumed at Step S203, the descriptive data which describes the network of the communities created at Step S204 and the index of the network within and without the community calculated at Step S205 (Step S206), and ends the second analysis process.

By the second analysis process, the configuration of the community of the companies and the descriptive data which describes the network of the communities are stored each time the financial institution database 201 and the credit investigation result database 202 are updated or periodically.

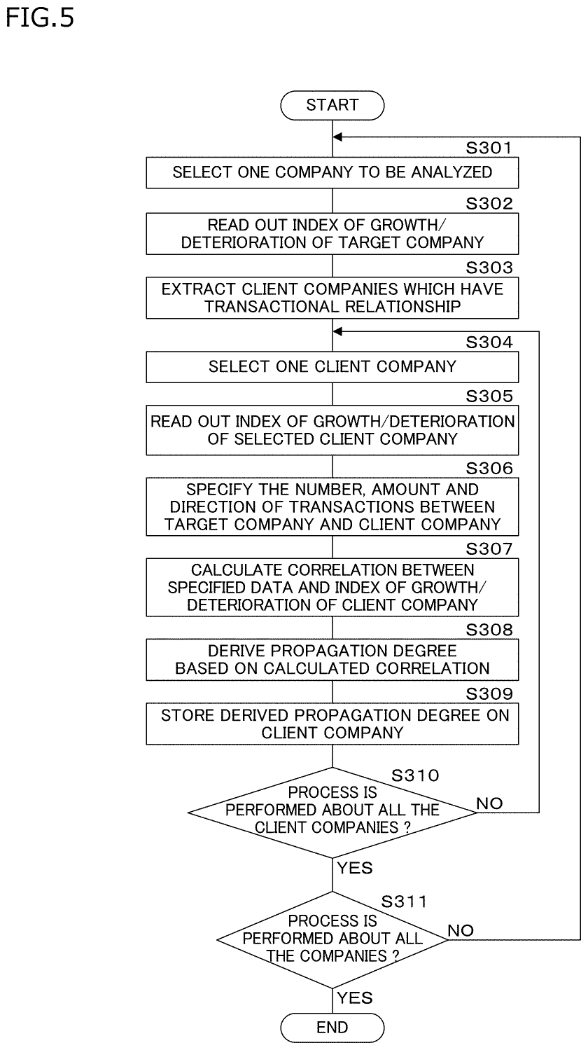

FIG. 5 is a flowchart showing one example of a third analysis process procedure by the analysis apparatus 1. The processing unit 10 selects one company to be analyzed from the company data stored in the storage unit 11 (Step S301), and reads out the index of growth/deterioration derived for the selected target company (Step S302).

The processing unit 10 extracts client companies which have a transactional relationship with the selected target company based on the exchange data of the financial institution database 201 and/or the company correlation data of the credit investigation result database 202 (Step S303).

The processing unit 10 selects one from the extracted client companies (Step S304). The processing unit 10 reads out the index of growth/deterioration derived for the selected client company in a target period (Step S305).

The processing unit 10 specifies, from the data of the financial institution database 201 and/or the credit investigation result database 202, the number of transactions, a transaction amount and a transactional direction between the selected target company and the client company selected at Step S304 (Step S306).

The processing unit 10 calculates a numerical value indicating a correlation of the number of transactions, the transaction amount (the transaction volume) and the transactional direction which are specified between the selected target company and the client company, with the index of growth/deterioration of the client company (Step S307).

At Step S307, the target period of the data such as the number of transactions, the transaction amount and the transactional direction may be the same as that of the data of the index of the growth/deterioration which correlates therewith, or there may be a difference of an update interval of the database, a calculation interval of the index, or a fixed period such as a year, a month, a quarter or a half year.

The processing unit 10 derives a propagation degree based on the numerical value of the correlation calculated at Step S307 and on the transactional direction (Step S308). At Step S308, the processing unit 10 derives as the “propagation degree” expressed by percentage an influence degree of the index of the growth/deterioration of the selected target company, on a change in index of growth/deterioration of the client, for example. A propagation direction may be specified by the transactional direction (a request, a request destination). At Step S308, the processing unit 10 may calculate a percentage of each transaction amount between the target company and a client company, to total transaction amount as the propagation degree.

The processing unit 10 stores the propagation degree on the client company derived at Step S308 in association with the company IDs of the target company and the client company (Step S309).

The processing unit 10 determines whether or not all the client companies are selected from the client companies extracted at Step S303 (Step S310), and when the processing unit 10 determines that all the client companies are not selected (S310: NO), the processing unit 10 returns the process to Step S304.

When the processing unit 10 determines that all the client companies are selected at Step S310 (S310: YES), the processing unit 10 determines whether or not all the target companies are selected (Step S311), and when the processing unit 10 determines that all the target companies are not selected (S311: NO), the processing unit 10 returns the process to Step S301. When the processing unit 10 determines that all the target companies are selected at Step S311 (S311: YES), the processing unit 10 ends the process of the third step.

The process of the third step may be performed by a statistical procedure such as the calculation of a correlation as shown in the flow chart of FIG. 5, or the process of the third step may be realized by an analytic operator's work as shown in the flow chart of FIG. 6. The analytic operator has an operation authority of the analysis apparatus 1, and operates the analysis apparatus 1 via a terminal apparatus comprising a communication section and an input/output interface.

FIG. 6 is a flowchart showing other one example of the third analysis process procedure by the analysis apparatus 1. About processes in the process procedure shown in the flow chart of FIG. 6 common to the processes of the process procedure shown in the flow chart of FIG. 5, the same step numbers are assigned and a detailed explanation thereof is omitted.

In a case of realizing the process procedure by an operator's work, the processing unit 10 outputs a screen showing the index read at Step S302, the index read at Step S305, the number of transactions specified at Step S306, the transaction amount and the transactional direction via the communication unit 12 (Step S317). An output destination is a display of the terminal apparatus used by the operator.

The processing unit 10 accepts an input of the propagation degree on the screen outputted at Step S317 (Step S318). The input is performed via an input interface such as a pointing device, a keyboard which is used with a personal computer used by the operator.

The processing unit 10 stores the accepted propagation degree in association with the company IDs of the target company and the client company (Step S319), and advances the process to Step S310.

In this way, the propagation degree by an empirical evaluation of the operator for the analysis process may be used. The processing unit 10 may give the propagation degree accepted at Step S318 as a teacher data of a model with a neural network defined as outputting a score in a case where the data such as the index of the growth/deterioration read at Step S302, the index of the growth/deterioration of the client company read at Step S305 and the number of transactions specified at Step S306 is inputted, generate this model as a learning model, and use this model.

By the third analysis process, the propagation degree indicating the influence degree of the index of growth/deterioration of each company on other company is derived and stored each time the financial institution database 201 and the credit investigation result database 202 are updated or periodically.

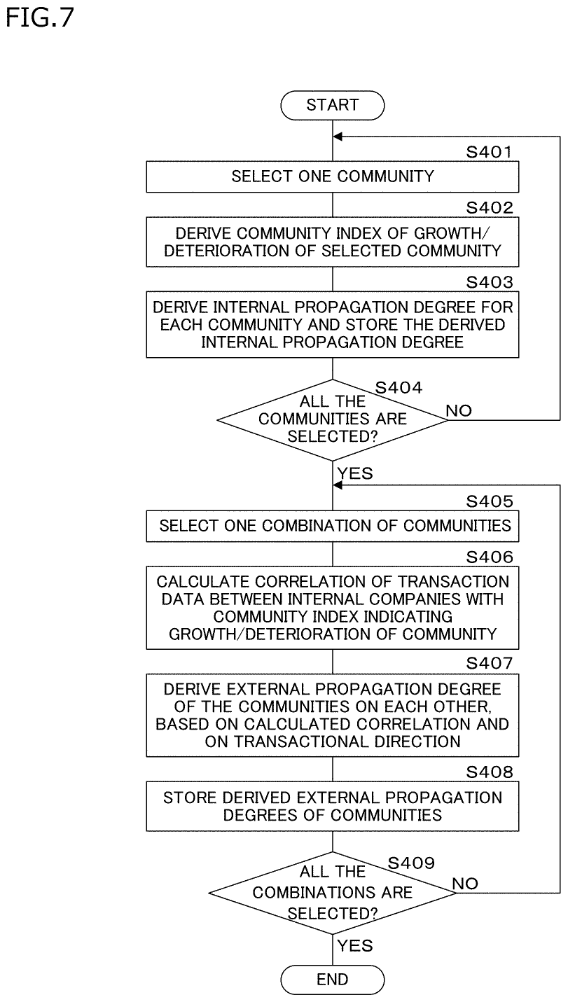

Next, a propagation degree of the growth/deterioration in a community is analyzed. FIG. 7 is a flowchart showing one example of a fourth analysis process procedure.

The processing unit 10 selects one community (community ID) from the communities detected by the second analysis process (Step S401).

The processing unit 10 derives a community index of growth/deterioration of the community shown with the selected community ID by means of the indexes indicating growth/deterioration of the companies belonging to the community (Step S402).

At Step S402, the processing unit 10 derives the community index of the whole community by the statistical procedure of indexes of growth/deterioration derived for the companies belonging to the community. For example, the processing unit 10 may calculate an average value of indexes of growth/deterioration derived for the companies belonging to the community, or may calculate a mode thereof etc. When the processing unit 10 calculates an average value, the processing unit 10 preferably calculate dispersion of the derived indexes of growth/deterioration. In a case where the index of growth/deterioration is expressed as a label indicating any of a plurality of steps of growth/normal/gaze, a numerical value (1, 0, −1) may be applied thereto and a label corresponding to the average value, and a qualitative evaluation corresponding to the dispersion (a normal range closer to growth, etc.) may be derived.

The processing unit 10 derives an internal propagation degree of the community index on the companies belonging to the community, based on the community index derived at Step S402, and stores the internal propagation degree in association with the community ID (Step S403).

At Step S403, the processing unit 10 derives an internal propagation degree by means of a size of dispersion of the indexes of growth/deterioration of the internal companies. For example, the processing unit 10 may derive an internal propagation degree by means of a predetermined function of the dispersion. When the dispersion is larger than a predetermined value, the processing unit 10 derives a low internal propagation degree because the growth/deterioration is not linked as the whole community. On the contrary, when the distribution is equal to or smaller than the predetermined value, the processing unit 10 derives a high internal propagation degree because the growth/deterioration is easily linked as the whole community.

The processing unit 10 determines whether or not all the communities are selected (Step S404), and when the processing unit 10 determines that all the communities are not selected (S404: NO), the processing unit 10 returns the process to Step S401 to analyze the other community.

When the processing unit 10 determines that all the communities are selected at Step S404 (S404: YES), the processing unit 10 selects one combination of communities (Step S405). The processing unit 10 calculates a numerical value indicating a correlation of the data such as the number of transactions, the transaction amount and the transactional direction between the selected combination of communities and between the internal companies, with the community index indicating the growth/deterioration of the community (Step S406).

The processing unit 10 derives an external propagation degree of the communities included in the combination on each other, based on the numerical value of the correlation calculated at Step S406 and on the transactional direction between the internal companies (Step S407). At Step S407, the processing unit 10 derives as the external propagation degree expressed by percentage an influence degree of the community index of growth/deterioration of the target community, on a change in community index of growth/deterioration of the associated community. As the correlation is higher, the propagation degree is calculated higher.

The processing unit 10 stores the external propagation degree of growth/deterioration of the communities on each other derived at Step S407 in association with the company ID (Step S408).

The processing unit 10 determines whether or not all the combinations are selected (Step S409), and when the processing unit 10 determines that all the combinations are not selected (S409: NO), the processing unit 10 returns the process to Step S405.

When the processing unit 10 determines that all the combinations are selected (S409: YES), the processing unit 10 ends the fourth analysis process.

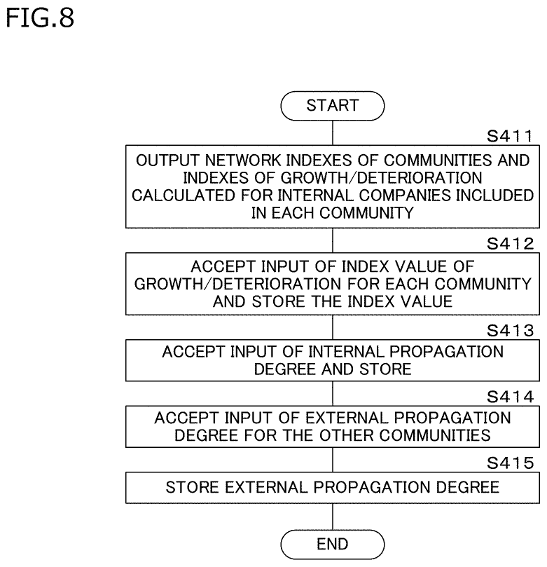

The process of the fourth step may be performed by the statistical procedure based on a correlation as shown in the flow chart of FIG. 7, or may be realized by an analytic operator's work as shown in the flow chart of FIG. 8.

FIG. 8 is a flowchart showing other one example of the fourth analysis process procedure by the analysis apparatus 1. In a case of realizing the process procedure by an operator's work, the processing unit 10 outputs statistical data of the communities including the network indexes of the communities detected by the second analysis process and the indexes of growth/deterioration calculated for the internal companies included in each community (Step S411). An output destination is a display of the terminal apparatus used by the operator. About the indexes of growth/deterioration of the internal companies, data (an average value, a mode, etc., for example) after the statistical process may be outputted.

The processing unit 10 accepts an input of an index value of growth/deterioration for each community on the screen outputted at Step S411, and stores the index value in association with the community ID (Step S412). At Step S412, the operator may empirically give a label of growth/normal/gaze by reference to the displayed statistics of the network index and the indexes of growth/degradation of the internal companies.

The processing unit 10 accepts on the screen outputted at Step S411 an input of an internal propagation degree of growth/deterioration of the community on the internal companies, and stores the internal propagation degree (Step S413). Also, about the internal propagation degree, an operator empirically inputs a result determined by reference to the various data displayed on the screen.

The processing unit 10 accepts an input of an external propagation degree of growth/deterioration of the communities on the screen outputted at Step S411 (Step S414), stores the external propagation degree in association with the community ID (Step S415) and ends the fourth analysis process.

Also, at Step S414, the operator empirically inputs an external propagation degree determined by reference to the various data displayed on the screen.

The process procedure shown in the flow chart of FIG. 8 may be performed after the process procedure shown in the flow chart of FIG. 7, and the check and adjustment by the operator may be accepted.

By the fourth analysis process, the internal/external propagation degree indicating the influence degree of the index of growth/deterioration of the community on the internal companies and the influence degree of the index on the communities respectively is derived and stored each time the financial institution database 201 and the credit investigation result database 202 are updated or periodically. The fourth analysis process may be performed when the invoice/voucher database 203 or news database 204 is updated.

The indexes of growth/deterioration of the individual companies may be adjusted by means of the internal/external propagation degree obtained by the fourth analysis process at this time. The processing unit 10 may adjust the index of growth/deterioration derived for each company by adding a weight of the internal propagation degree of the community to which the company belongs, to the index of growth/deterioration of the community itself. For example, even when an index of growth/degradation of each of companies expresses remarkable growth, the processing unit 10 revises downward the index of each of the companies in a case where the index of growth/deterioration of the community itself indicates gaze and where the internal propagation degree is high. In a case where the internal propagation degree is low, the downward revision is preferably adjusted smaller. Also in the other example, even when an index of growth/degradation of each of companies expresses gaze (deterioration), the processing unit 10 may revise upward the index of each of the companies to adjust the index so as to express low growth in a case where the index of growth/deterioration of the community itself indicates growth and where the internal propagation degree is high.

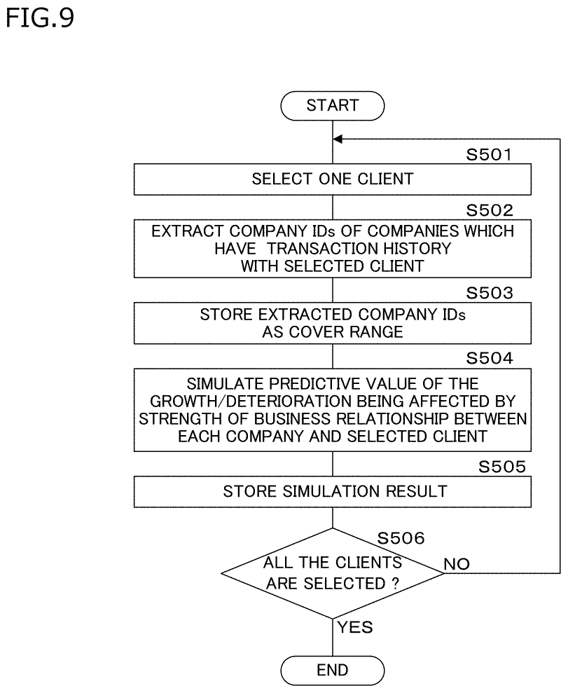

Next, the processing unit 10 of the analysis apparatus 1 conducts an analysis for a client-based display output. FIG. 9 is a flowchart showing one example of a fifth analysis process procedure by the analysis apparatus 1.

The processing unit 10 selects one client from the client data stored in the storage unit 11 (Step S501), and extracts company IDs of companies which have a transaction history with the financial institution or company being the selected client (Step S502).

The processing unit 10 stores the company IDs extracted at Step S502 as a cover range, in association with the client ID of the selected client (Step S503). The cover range means accessible data for the selected client. In the case where the selected client is a financial institution, the cover range means data of companies which respectively have accounts with the financial institution. In the case where the selected client is a management consultant, the cover range means data of companies which permits to disclose data to the management consultant.

The processing unit 10 simulates a predictive value of the growth/deterioration in a case of conducting an activity for activating a company (increase in loan), based on the index of growth/deterioration of each company, the community index of growth/deterioration of the community including the companies and the propagation degree, for each company which has the transaction history with the selected client (Step S504). In the simulation, what growth/deterioration in a case where what kind of correspondence is given is predicted at a plurality of steps between the activation (increase in loan amount) and the non-activation (no loan).

The processing unit 10 stores the simulation result in association with the client ID and the company ID of the transaction company (Step S505), and determines whether or not all the clients are selected (Step S506). When the processing unit 10 determines that all the clients are not selected (S506: NO), the processing unit 10 returns the process to Step S501.

When the processing unit 10 determines that all the clients are selected (S506: YES), the processing unit 10 ends the fifth analysis process.

By the fifth analysis process, the below-described display output is performed smoothly. Note that the process shown in the flow chart of FIG. 5 may be performed at the time of the below-described display output.

About the above-described first to fifth analysis process procedures, the processing unit 10 may perform parts thereof in parallel, or may repeatedly perform the analysis by the second, third and fourth analysis process procedures and then perform the process procedure of the next step.

The result obtained by the above-described analysis process can be displayed by the information terminal apparatus 3 according to the request transmitted from the information terminal apparatus 3 and can be checked by a client.

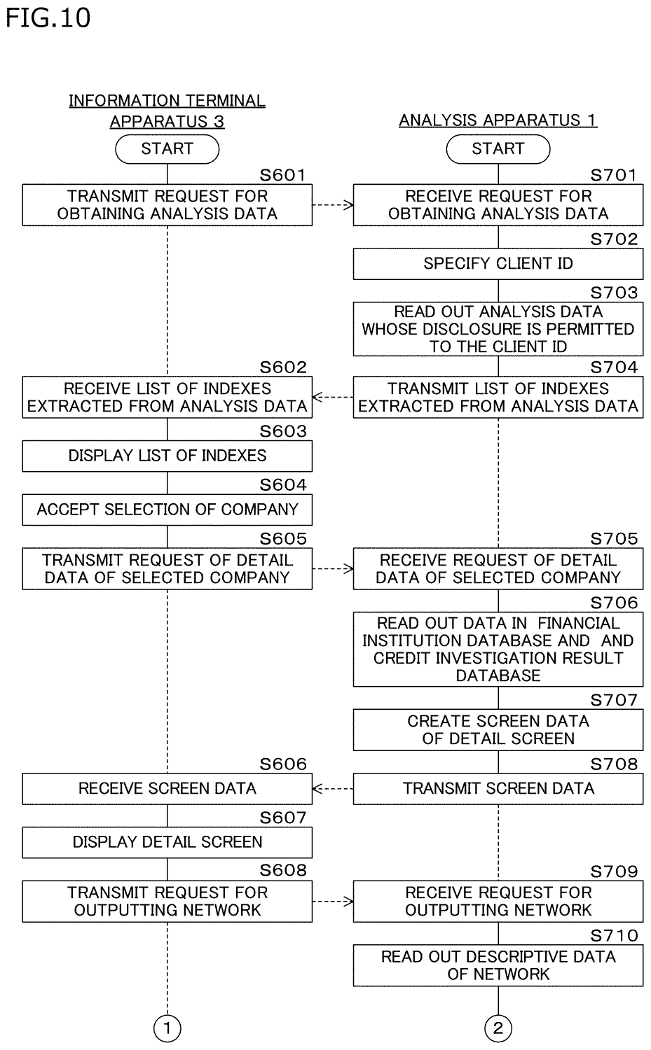

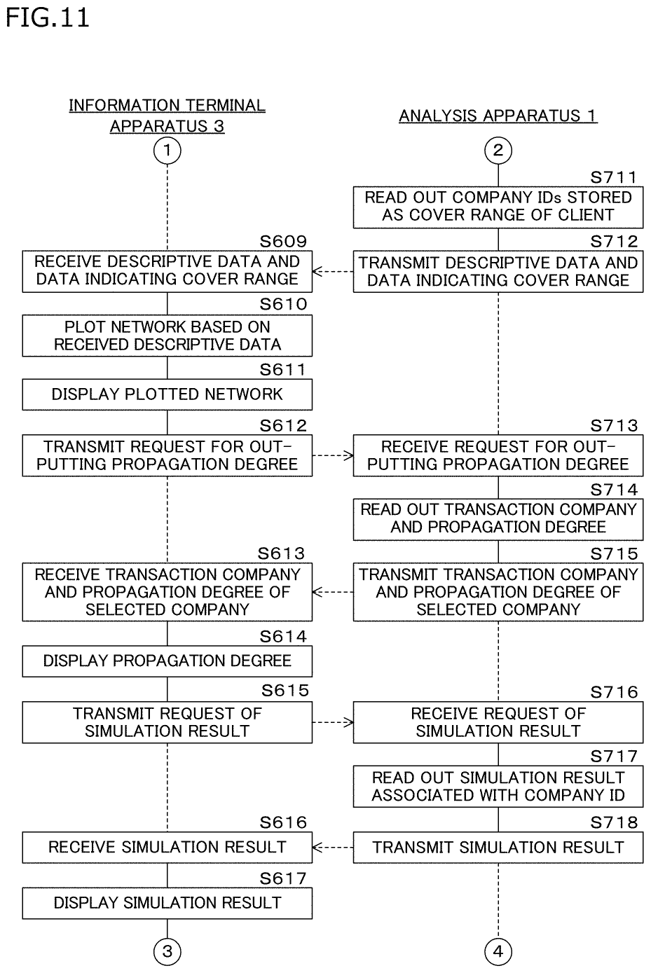

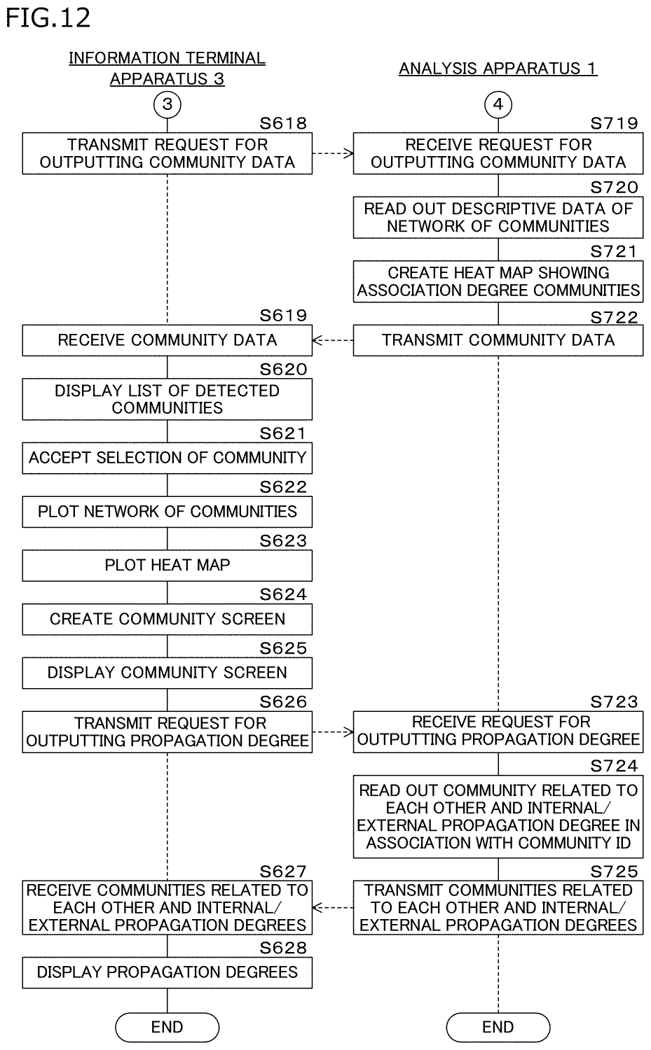

FIGS. 10 to 12 are flowcharts showing one example of the process procedure of outputting the analysis result by the information terminal apparatus 3. When the communication connection is established between the information terminal apparatus 3 and the analysis apparatus 1, the following processes are performed according to an operation of a user who is a client in the information terminal apparatus 3.

The flow charts of FIG. 10 to FIG. 12 are merely one example, and an order of a display is not restricted to the below-described example, and may be realized by various methods according to the menu design of the screen displayed on the display unit 32 and the response design to an operation by the operating unit 33.

The processing unit 30 of the information terminal apparatus 3 transmits a request for obtaining analysis data to the analysis apparatus 1 with the client's account information read from the storage unit 31 (Step S601).

In the analysis apparatus 1, when the request for obtaining analysis data is received (Step S701), the processing unit 10 specifies a client ID from the account information included in the request (Step S702), and reads out the analysis data whose disclosure is permitted to the client ID from the storage unit 11 or the storage apparatus 2 (Step S703).

The analysis data is data created and performed in the first to fifth analysis process procedures as explained with reference to the flow charts of FIG. 3 to FIG. 9. The analysis data whose disclosure is permitted is data which is permitted in association with the account information, such as a period, a target company, a number and a data volume, in these analysis data created and stored in the past and the latest.

The processing unit 10 extracts a list of indexes of growth/deterioration for each target company to be analyzed from the read analysis data, and transmits the list from the communication section 13 towards the information terminal apparatus 3 (Step S704).

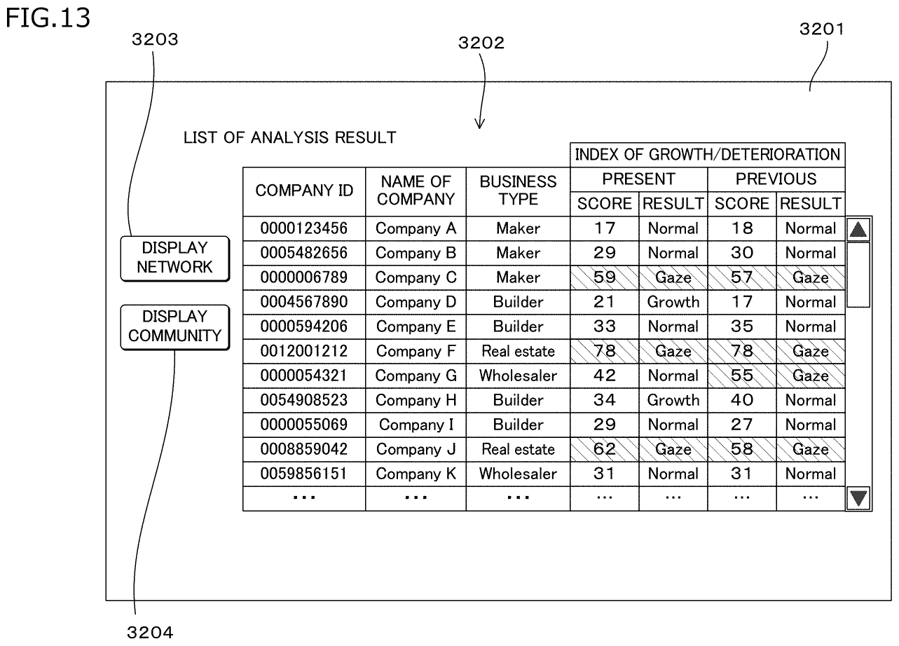

In the information terminal apparatus 3, the list of indexes of growth/deterioration for each target company is received (Step S602), and the processing unit 30 causes the display unit 32 to display the list (Step S603). The list is displayed so as to be arbitrarily sorted in descending or ascending order of the indexes of growth/deterioration (refer to FIG. 13).

The processing unit 30 accepts selection of a company from the list (Step S604), and transmits to the analysis apparatus 1 a request of detail data which specifies a company ID of the selected company (Step S605).

In the analysis apparatus 1, when the request of detail data is received (Step S705), the processing unit 10 reads out data in the financial institution database 201 and the credit investigation result database 202 which are stored in association with the company ID specified at the request (Step S706). The processing unit 10 may read out data in the invoice/voucher database 203 or in the news database 204 at Step S706. The processing unit 10 creates screen data of a detail screen for displaying the detail data including graphs etc. based on the read financial data and deposit/withdrawal data (Step S707), and transmits the created screen data to the information terminal apparatus 3 (Step S708).

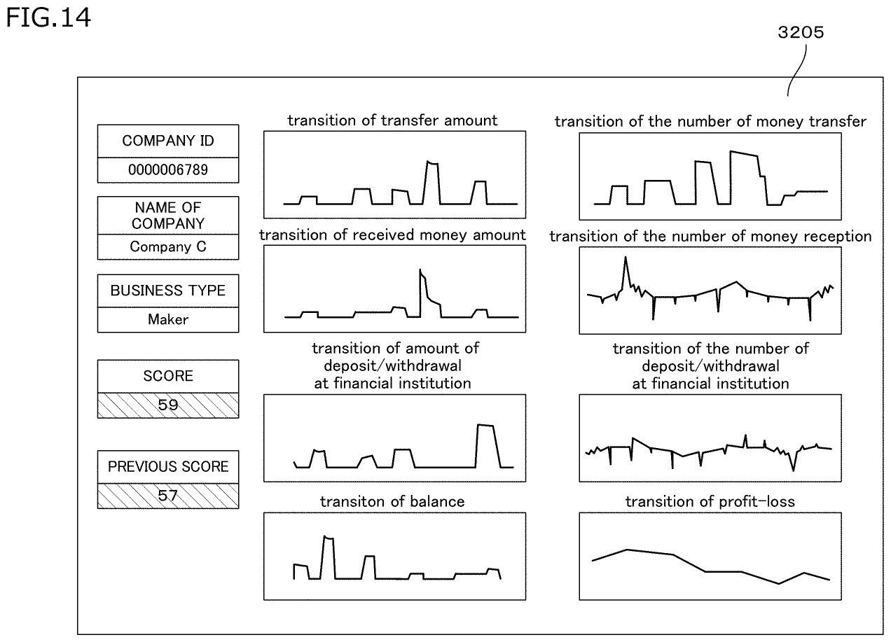

In the information terminal apparatus 3, when screen data corresponding to the request of detail data is received (Step S606), a screen showing the detail data is outputted to the display unit 32 based on the screen data (Step S607). Thereby, the display unit 32 displays the graphs, such as a deposit/withdrawal history and a transfer-number history with the index of growth/deterioration of the target company selected at Step S604 (refer to FIG. 14).

The processing unit 30 of the information terminal apparatus 3 transmits a request for outputting a network to the analysis apparatus 1 (Step S608).

In the analysis apparatus 1, when the request for outputting a network is received (Step S709), the processing unit 10 reads out the descriptive data of the network of companies from the storage unit 11 or the storage apparatus 2 (Step S710). The processing unit 10 reads out the company IDs stored as the cover range of the client who uses the information terminal apparatus 3 (Step S711). The processing unit 10 transmits to the information terminal apparatus 3 a part of the descriptive data and data indicating the cover range (Step S712).

In the information terminal apparatus 3, the descriptive data transmitted according to the request for outputting the network is received (Step S609), and based on the received descriptive data, the network is plotted by marking each company as the node and marking the transactional relationships as the edges (Step S610). The network is preferably plotted based on the data indicating the cover range so that the cover range can be specified by coloring, a kind of hatching, etc.

The processing unit 30 causes the display unit 32 to display the plotted network (Step S611). The processing unit 30 preferably transmits to the analysis apparatus 1 a request of the descriptive data of the other portion of the network according to an operation by the operating unit 33 on the screen displayed in the display unit 32, and updates the screen each time a response to the request is received.

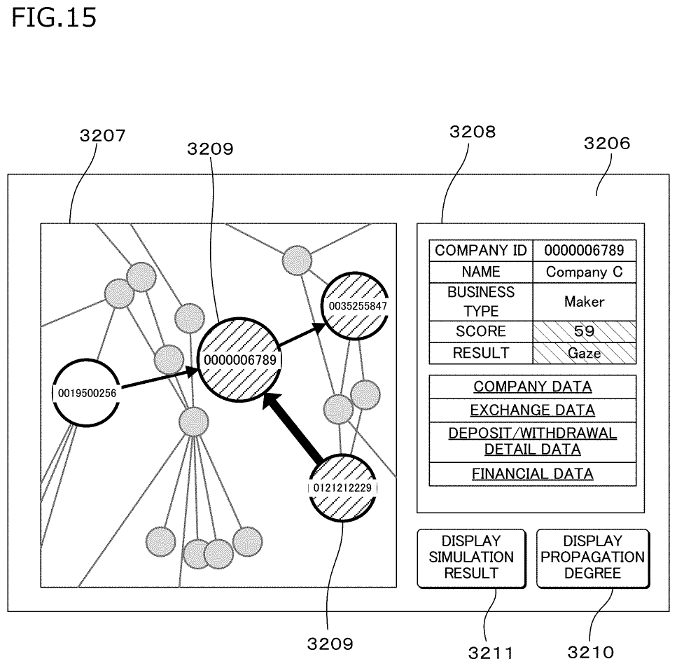

At Step S611 the network is plotted and displayed by marking each company as the node and marking the transactional relationships as the edges (refer to FIG. 15). Each node in the network displayed in the display unit 32 can be selected by the operating unit 33, and when selected, a text or an image of the index of growth/deterioration is displayed.

The information terminal apparatus 3 transmits to the analysis apparatus 1 a request for outputting a propagation degree of the company selected at Step S604 on the other company (Step S612).

In the analysis apparatus 1, when the request for outputting a propagation degree is received (Step S713), the processing unit 10 reads out the transaction company stored in association with the company ID of the company specified at the request and the propagation degree on each company (Step S714). The processing unit 10 transmits the read transaction company and propagation degree (Step S715). At this time, the processing unit 10 may separately transmit the index of growth/deterioration adjusted with the propagation degree associated with the company ID of the selected company.

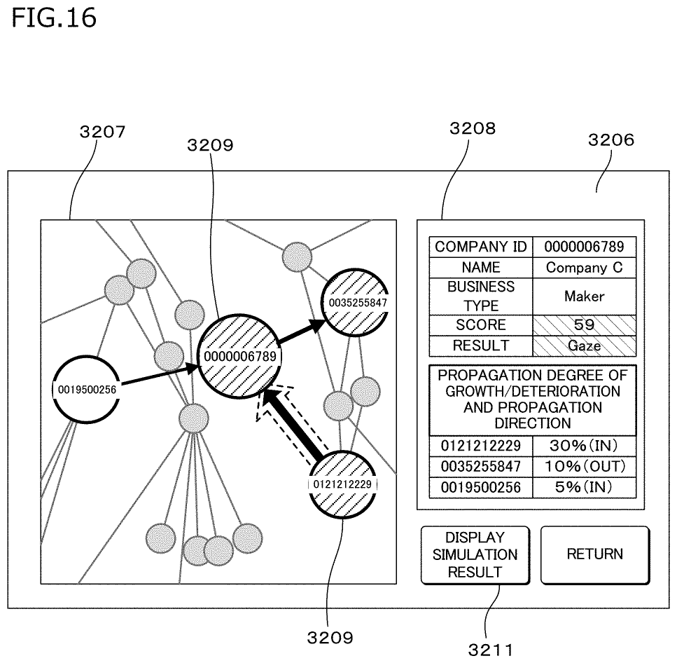

The information terminal apparatus 3 receives the transaction company and the propagation degree of the selected company (Step S613), and the processing unit 30 causes the display unit 32 to display an image or a table showing the transaction company and the propagation degree on the displayed network (Step S614). At Step S614, the propagation degree of growth/deterioration of the selected company on the transaction company is visualized (refer to FIG. 16).

The information terminal apparatus 3 transmits to the analysis apparatus 1 a request of a simulation result in case of strengthening or weakening the relationship with the selected company (Step S615).

In the analysis apparatus 1, when the request of a simulation result is received (Step S716), the processing unit 10 reads out from the storage unit 11 or the storage apparatus 2 the simulation result associated with the company ID of the company specified at the request (Step S717). The processing unit 10 transmits the read simulation result to the information terminal apparatus 3 (Step S718).

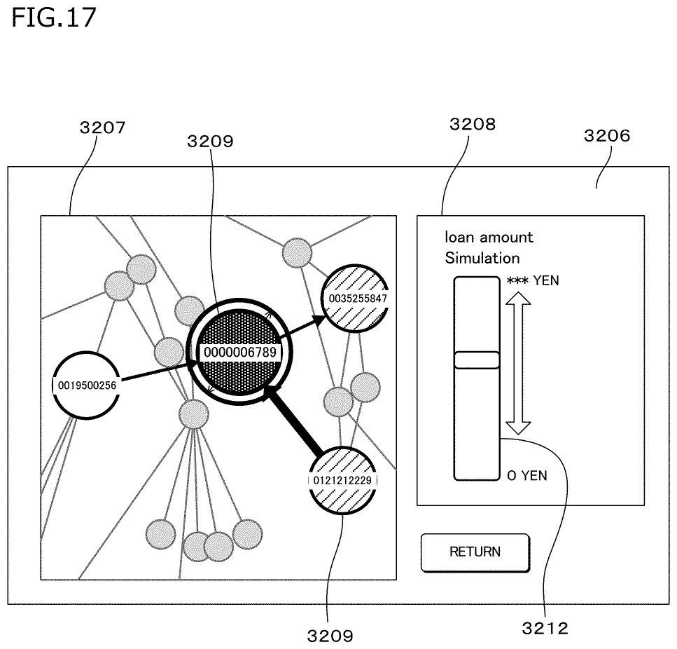

The information terminal apparatus 3 receives the simulation result transmitted according to the request of the simulation result (Step S616). The processing unit 30 causes the display unit 32 to display the received simulation result with the displayed network (Step S617). At Step S617, visualized is the simulation result of the ripple effect on the growth/deterioration of the target company in a case where the relationship with the select company is strengthened and where a case where the relationship with the select company is weakened (refer to FIG. 17).

The information terminal apparatus 3 transmits to the analysis apparatus 1 a request for outputting community data (Step S618).

In the analysis apparatus 1, when the request for outputting community data is received (Step S719), the processing unit 10 reads out the descriptive data of the network of communities from the storage unit 11 or the storage apparatus 2 (Step S720). The processing unit 10 creates a heat map showing an association degree of the communities (Step S721).

The processing unit 10 transmits to the information terminal apparatus 3 community data including the list of the detected communities, the descriptive data and the heat map data (Step S722).

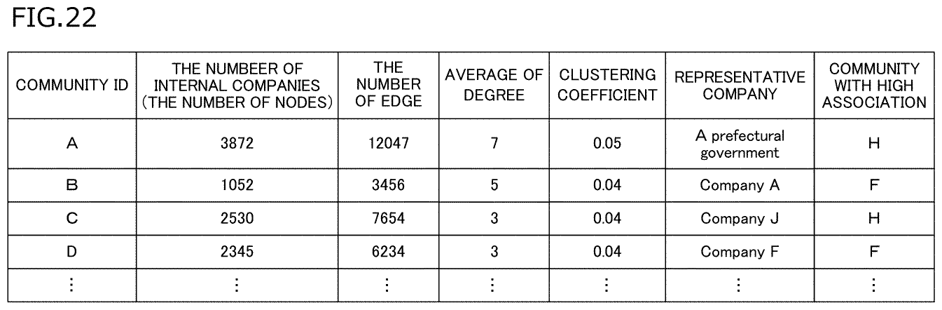

The information terminal apparatus 3 receives the community data transmitted according to the request for outputting the community data (Step S619). The processing unit 30 causes the display unit 32 to display the list of the detected communities included in the received community data (Step S620). At Step S620, the detected communities and the network index of each community etc. are displayed (refer to FIG. 22).

The processing unit 30 accepts selection of any community from the list (Step S621), and plots the network of communities based on the descriptive data included in the received community data by marking the selected community in the center, marking each company as the node and marking the association relationships of the communities as the edges (Step S622). The processing unit 30 plots a heat map indicating the height of the association of the communities based on the heat map data (Step S623).

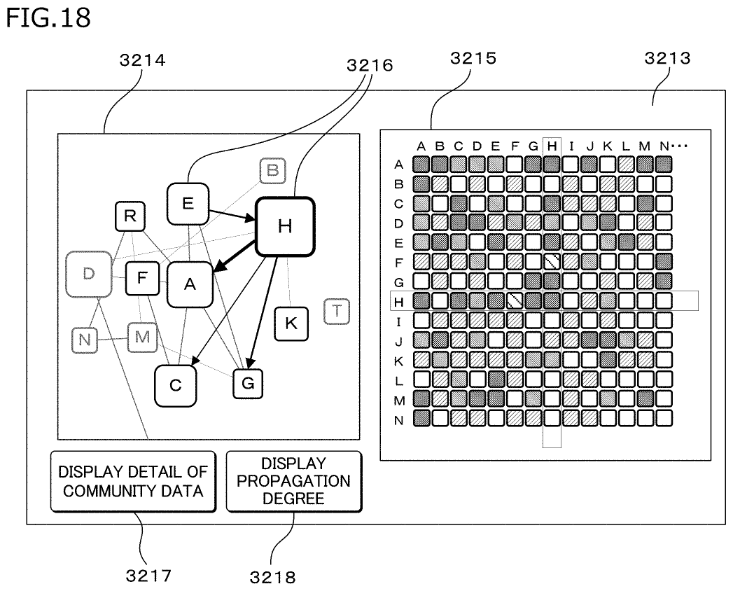

The processing unit 30 creates a community screen including the network plotted at Step S622 and the heat map plotted at Step 623 (Step S624), and causes the display unit 32 to display the community screen (Step S625). At Step S625, the network is plotted and displayed by marking each company as the node and marking the association relationships as the edges (refer to FIG. 18). Each node in the network displayed in the display unit 32 can be selected by the operating unit 33, and when selected, a text or an image of the index of growth/deterioration of the selected community is displayed.

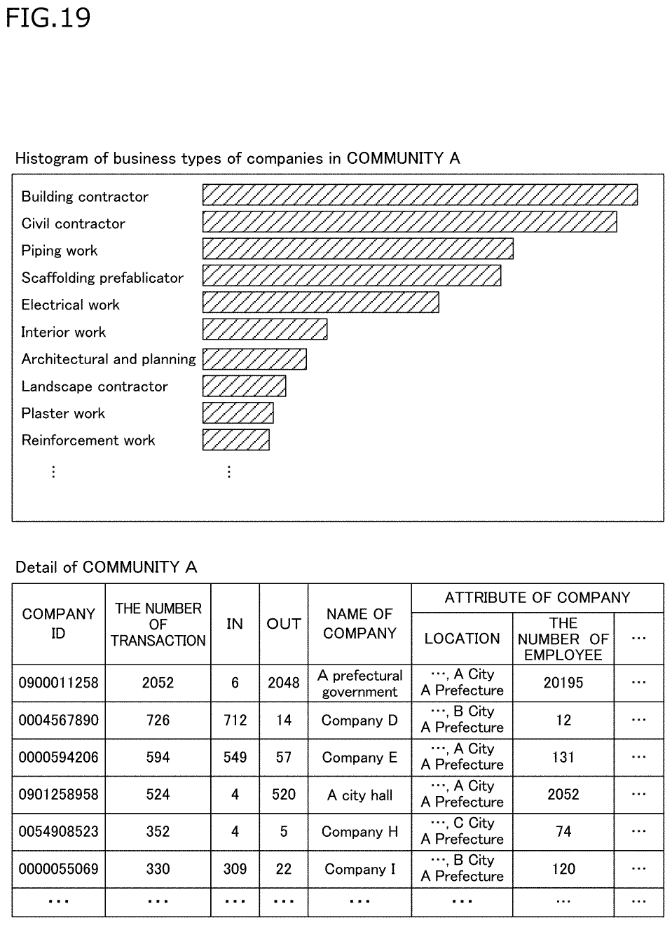

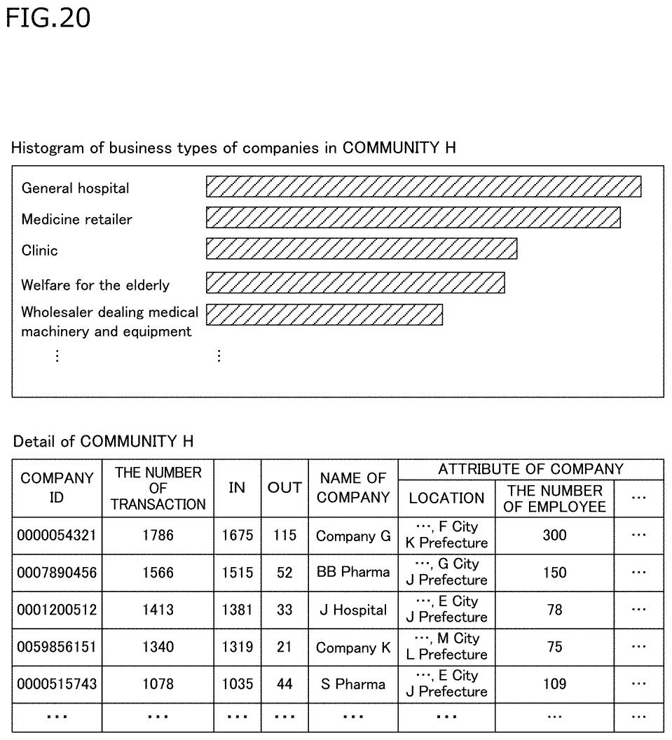

The processing unit 30 preferably causes the display unit 32 to highlightedly display the selected community according to an operation by the operating unit 33 on the community screen displayed in the display unit 32. The processing unit 30 transmits to the analysis apparatus 1 the request of the detail data of the selected community each time the community is selected according to an operation by the operating unit 33, and when the response to the request is received, the detail is preferably displayed on the screen (refer to FIGS. 19 and 20).

The information terminal apparatus 3 transmits to the analysis apparatus 1 a request for outputting a propagation degree on the companies in the community selected at Step S616 and the other community (Step 626).

In the analysis apparatus 1, when the request for outputting a propagation degree is received (Step S723), the processing unit 10 reads out the internal propagation degree on the companies in the community stored in association with the community ID of the community specified at the request, other community which has the association relationship and the external propagation degree of growth/deterioration on the other community (Step S724). The processing unit 10 transmits the read community related to the community specified at the request and internal/external propagation degrees (Step S725).

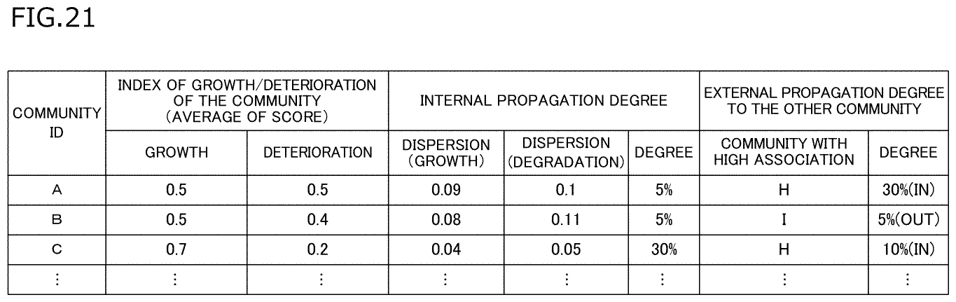

The information terminal apparatus 3 receives the other community which has the association relationship with the selected community and the propagation degrees (Step S627), and causes the display unit 32 to display a table of the internal/external propagation degree on the companies in the community, the other community which has the association relationship, and the internal/external propagation degree of growth/deterioration on the other community (Step S628). At Step S628, the internal/external propagation degree of growth/deterioration of the selected community on the other community is visualized (refer to FIG. 21).

By these display processes, the information terminal apparatus 3 ends the output of the analysis result of the company.

The process procedure shown in the flow charts of FIG. 10 to FIG. 12 is preferably performed in the background in the Web browser activated in the information terminal apparatus 3, and the analysis data required at each display timing of each page is preferably transmitted from the analysis apparatus 1 to the information terminal apparatus 3.

FIGS. 13 to 22 are screen examples displayed in the information terminal apparatus 3. FIG. 13 is a display example of a main screen 3201. The main screen 3201 includes a list 3202 of indexes of growth/deterioration of the target companies to be analyzed which is permitted to the account information of a user who operates. The main screen 3201 includes a network display menu 3203 and a detection community display menu 3204.

FIG. 14 shows an example of a display screen 3205 of detail data. FIG. 14 shows the display screen 3205 displayed in a case where any company is selected on the main screen 3201 shown in FIG. 13. When a company ID or a company name of any company in the list 3202 is selected on the main screen 3201, the operating unit 33 detects such a selection, and the processing unit 30 of the information terminal apparatus 3 transmits to the analysis apparatus 1 a request of detail data shown at Step S605 in the above-described process procedure. In response to the request of detail data, the analysis apparatus 1 transmits screen data in which various data read from the financial institution database 201 and the credit investigation result database 202 as shown in the example of FIG. 2 are shown graphically as shown in FIG. 14. The client user can check the transition of deposit/withdrawal and the transition of the financial data and the like of the target company on the display screen 3205 shown in FIG. 14.

FIG. 15 shows an example of a network display screen 3206. FIG. 15 shows the network display screen 3206 displayed in a case where the network display menu 3203 is selected on the main screen 3201 shown in FIG. 13. When the network display menu 3203 is selected on the main screen 3201 shown in FIG. 13, the processing unit 30 of the information terminal apparatus 3 transmits to the analysis apparatus 1 a request for outputting the network shown at Step S608 in the above-described process procedure. Thereby, the network display screen 3206 shown in FIG. 15 is displayed.

The network display screen 3206 includes a display area 3207 of a plotted network, and a related area 3208 for displaying data about a selected target company.

As shown in FIG. 15, a network displayed on the display area 3207 is expressed with a node 3209 which indicates each company in a circle and edges which indicate transactional relationships between companies and connect the nodes. In the example of FIG. 15, the node 3209 corresponding to a selected company and the node 3209 of the company which directly transacts with the selected company are displayed in large circles. Each node 3209 is a pointer operated by the operating unit 33 in the display area 3207, and can be selected.

The related area 3208 displays information of a company ID etc. in a case where a target company corresponding to any node 3209 in the display area 3207 is selected, and links to data of the target company in the financial institution database 201, and the like. The related area 3208 included in the network display screen 3206 displays data of a transaction company of the selected target company.

In the example of FIG. 15, the cover range of the client, i.e. the companies which can be covered are highlightedly displayed as shown by hatching (S611). Thereby, a distinction between the known company and the company whose details are unknown is clarified for the company of the client user who operates the information terminal apparatus 3. In a case where a relationship with the selected target company is strengthened, for example, in a case where a client is a financial institution and increases a loan, it is possible to visually and intuitively grasp whether the increase in loan has an effect on other transaction company and whether the increase in loan has an effect on other unknown company not being the client.

The network display screen 3206 shown in FIG. 15 also includes a propagation degree display menu 3210 for displaying a propagation degree from the selected target company to the transaction company which has the transactional relationship with the target company. When the propagation degree display menu 3210 is selected, the processing unit 30 of the information terminal apparatus 3 transmits to the analysis apparatus 1 a request for outputting a propagation degree of the selected target company (Step S612).

The network display screen 3206 shown in FIG. 15 may include a simulation display menu 3211. When the simulation display menu 3211 is selected, the processing unit 30 transmits to the analysis apparatus 1 a request of a simulation result of the selected target company.

FIG. 16 is a display example of a propagation degree. FIG. 16 is shown in a case where the propagation degree display menu 3210 is selected on the network display screen 3206 shown in FIG. 15. When the propagation degree display menu 3210 is selected, the propagation degree is highlightedly displayed as shown with a dashed line surrounding an arrow connecting the nodes 3209 in the display area 3207. Of course, the propagation degree may be highlightedly displayed by other modes, such as a change in color and a blink of a display. When the propagation degree display menu 3210 is selected, the related area 3208 displays detail data of the propagation degree. The detail data of the propagation degree includes a numerical value indicating the propagation degree on other company which transacts directly, and a propagation direction.

FIG. 17 is a display example of a simulation result. FIG. 17 shows the display example displayed in a case where the simulation display menu 3211 included in the network display screen 3206 shown in FIG. 15 is selected. As shown in FIG. 17, when the simulation display menu 3211 is selected, the related area 3208 displays a control 3212 for adjusting the strength or weakness of the relationship, for example, the increase or decrease in loan amount. In the example of FIG. 17, the control 3212 is a slider control. When the strength or weakness of the relationship is adjusted by the control 3212, the processing unit 30 outputs the ripple effect to the related area 3208 based on the simulation result received from the analysis apparatus 1. The processing unit 30 may output the ripple effect to the display area 3207 of the network with a shade of a color of the node 3209 of the target company in the network, a change in size of the node 3209, and also a shade of a color or a change in size of the node 3209 of the client according to the propagation degree of growth/deterioration.

FIG. 18 shows an example of contents of a community screen 3213. The community screen 3213 includes a network display area 3214 and a heat map display area 3215. The network display area 3214 and the heat map display area 3215 may be displayed as an independent screen, respectively.

A network displayed on the network display area 3214 is expressed with a node 3216 which indicates each company in a square and edges which indicate transactional relationships between communities and connect the nodes. In the example of FIG. 18, the node 3216 corresponding to a selected community and the node 3216 corresponding to a community which has a high association degree with the selected community are displayed in large squares. Each node 3216 is a pointer operated by the operating unit 33 in the network display area 3214, and can be selected.

A heat map displayed on the heat map display area 3215 indicates association degrees of communities in the shape of a matrix. The heat map is a matrix in which each community is arranged in a row direction and a column direction. The height of the association degree is indicated with a shade of a color of a square object on the heat map. The height of the association degree is limited to a shade of a color, and may be indicated by blink of an object on a screen, or a difference in height with a three-dimensional map. The example of FIG. 18 shows that a color of a square object corresponding to an intersection of a row or column of communities whose community IDs are “H” and a row or column of communities whose community IDs are “A” is darker than colors of the other objects, and the association degree is high.

By referring to the community screen 3213 shown in FIG. 18, a client or an analysis operator intuitively and visually grasps the height of the association degree of the detected communities, and in a case where an activity for activating one community is conducted, the client or analysis operator can grasp an influence on other community.

The community screen 3213 illustrated in FIG. 18 includes a community detail display menu 3217 for displaying more detail data of internal companies of a selected target community, and a characteristic of a network in the target community, and the like. The community screen 3213 includes a propagation degree display menu 3218 for displaying a propagation degree of growth/deterioration of a community on other community.

FIG. 19 is a view showing an example of contents of a detected community. The example of contents of a community shown in FIG. 19 is also a screen example displayed in a case where the node 3216 corresponding to each community on the community screen 3213 shown in FIG. 18 is selected and the menu which displays detail data is selected.

The example of FIG. 19 shows a histogram of business types of companies included in a community, and a list of items of companies included in the community. The detected community shown in the example of FIG. 19 includes companies, such as a building contractor, a civil contractor, and a general piping work. The list of items of companies includes the number of transactions, and counts of destination and incoming of transactions. The list of items of companies includes attribute data of companies. The attribute data includes a location and the number of employees, and the like. When a community is sorted with a distribution of the number of transactions as shown in the list, it is assumed that a community of the building contractor and the civil contractor is detected with a focus on a prefectural office.

FIG. 20 is a view showing other example of contents of a detected community. FIG. 20 shows a histogram of business types of companies included in the community, and a list of attribute data of companies included in the community. The detected community shown in the example of FIG. 20 includes a general hospital, a medicine retailer, a clinic, and a company of welfare for the elderly. The list of items of companies includes the number of transactions, and counts of destination and incoming of transactions. The list of items of companies includes attribute data of the companies. The attribute data includes a location and the number of employees, and the like. When addresses included in the attribute data as shown in the list of items are referred, the community includes companies locating in the same region. Thus, the community is detected by the mathematical model, but it is assumed that the community is detected as a medical supply chain detected with the region.

By referring a list and a histogram of attribute data of companies included in a community as shown in FIG. 19 and FIG. 20, a client or an analysis operator can analyze the community.

FIG. 21 is a screen example showing a propagation effect of growth/deterioration of a community. FIG. 21 is the screen example displayed in a case where the propagation degree display menu 3218 is selected on the community screen 3213 shown in FIG. 18.

FIG. 21 shows data corresponding to internal propagation degrees in communities and propagation degrees on other communities which are derived by the process procedures shown in the flow charts of FIG. 7 or FIG. 8. The internal propagation degree is derived as dispersion of the index of growth/degradation of the community, as shown in FIG. 21.

FIG. 22 is a screen example showing network characteristics of communities. FIG. 22 is the screen example displayed in a case where the community detail display menu 3217 is selected on the community screen 3213 shown in FIG. 18.

FIG. 22 shows data of network indexes in communities derived by the process procedure shown in the flow chart of FIG. 4. The number of nodes corresponding to companies included in the community and the number of edges corresponding to the transactional relationships between the companies are displayed as statistical data. The network index includes an average of degrees of the network in the community, a clustering coefficient, a company name of the company corresponding to a node with the greatest number of transactions in the community. The network index also includes a community ID of the community with the highest association degree.

FIG. 17 is shown based on the simulation result (the flow chart of FIG. 9) in consideration of the propagation degree shown in the screen examples of FIG. 21 and FIG. 22. Thus, obtained is an index of growth/deterioration adjusted not only with an index of growth/deterioration of a target company but also with a propagation degree of growth/deterioration on other transaction company and a propagation degree of growth/deterioration on internal companies of a community itself. Thereby, an influence degree of growth/deterioration by strengthening or weakening a relationship from a client to a target company can be appropriately and correctly grasped visually as shown in FIG. 13 to FIG. 22.

It is to be noted that, as used herein and in the appended claims, the singular forms “a”, “an”, and “the” include plural referents unless the context clearly dictates otherwise.

The Embodiment disclosed in the above are illustrated in all aspects and should be regarded as not being limitative. The scope of the present invention is defined by the Claims, which intends to include all the meanings equivalent to the Claims and all the modifications within the scope.

1. A display method implemented by one or more processors, for displaying a transactional relationship of a plurality of organizations, comprising:
displaying a network composed of nodes and edges, the nodes representing the plurality of organizations respectively and the edge representing transactional relationships between the plurality of organizations, with an object indicating direction which highlights the edge according to the number of transactions, the transactional relationship and a transactional direction;
reading out an index related to growth derived by the processors or a computer for a target organization corresponding to the one of the nodes;
reading out a propagation degree of growth derived by the processors or a computer for the organization which has a transactional relationship with the target organization; and
displaying a text or an image, for one of the nodes, indicating the index and the propagation degree of growth.

2. The display method according to claim 1, further comprising displaying data of a plurality of communities which are detected from the plurality of organizations and into which the plurality of organizations are classified, by a network analysis of the network based on the number of transactions and a transaction amount of the plurality of organizations.

3. The display method according to claim 2, further comprising in a case where an activity for activating the target organization is conducted, based on a result obtained by simulating at a plurality of steps of activation a change in index concerning growth of the target organization due to an influence of the propagation degree of growth between the target organization and the organization which has a transactional relationship with the target organization and a community index concerning growth of the plurality of communities, displaying the change in index at the plurality of steps.

4. The display method according to claim 2, further comprising displaying a community network connecting the plurality of communities based on a transactional relationship of the organizations belonging to each community, the community network composed of nodes representing the communities and edges representing an association degree between the communities in accordance to the number of transactions and a transaction amount between the organizations belonging to each community.

5. The display method according to claim 2, further comprising displaying a map which plots a distribution of a height of an association degree between the plurality of communities presumed based on the number of transactions and a transaction amount between the organizations belonging to each community in a shape of a matrix in which each community is arranged in a row direction and a column direction,
wherein in the map the height of the association degree is indicated with a shade of a color of a part corresponding to an intersection of a row or a column of the communities.

6. The display method according to claim 2, wherein the displayed data of the community includes an organization list according to a business type distribution of the organizations belonging to the community and the number of transactions of the organizations belonging to the community.

7. An information apparatus, comprising:
a display device;
a communication device connectable to an analysis apparatus;
a storage device storing a display program; and
one or more processors in communication with the display device, the communication device and the storage device; the one or more processors being configured to executed the display program to implement:
transmitting a request of data for displaying an analysis result of a target organization to the analysis apparatus;
obtaining an index related to growth derived for a target organization corresponding to the one of the nodes, the index being transmitted from the analysis apparatus corresponding to the request;
obtaining a propagation degree of growth derived for the organization which has a transactional relationship with the target organization, the propagation degree being transmitted from the analysis apparatus corresponding to the request; and
displaying a screen based on the index and the propagation degree transmitted from the analysis apparatus according to the request,
wherein the screen includes:
a network created by marking a plurality of organizations including the target organization as nodes respectively and marking a transactional relationship between the plurality of organizations as an edge;
an arrow which highlights the edge according to the number of transactions, the transactional relationship and a transactional direction; and
when one of the nodes is selected, a text or an image indicating an index concerning growth derived for the target organization corresponding to the node and a propagation degree of growth on the organization which has a transactional relationship with the target organization.

8. A computer readable medium storing computer program executable by one or more processors of computer device having a display device and a communication device to display a transactional relationship between a plurality of organizations in the display device, the computer program causes the one or more processors to execute:
displaying a network composed of nodes and edges, the nodes representing the plurality of organizations respectively and the edge representing transactional relationships between the plurality of organizations, with an object indicating direction which highlights the edge according to the number of transactions, the transactional relationship and a transactional direction;
reading out an index related to growth derived by the processors or a computer for a target organization corresponding to the one of the nodes;
reading out a propagation degree of growth derived by the processors or a computer for the organization which has a transactional relationship with the target organization; and
displaying a text or an image, for one of the nodes, indicating the index and the propagation degree of growth.
